(19) United States
(12) Patent Application Publication
(10) Pub. No.: US 2019/0092939 A1
(43) Pub. Date: Mar. 28, 2019

(54) Anti-UV plastic for automobile interior ornaments

(71) Applicants: Naitian Zhang, Hangzhou (CN); Bin Chen, Hangzhou (CN); Rongfu Zhang, Hangzhou (CN); Ling Yin, Hangzhou (CN)

(72) Inventors: Naitian Zhang, Hangzhou (CN); Bin Chen, Hangzhou (CN); Rongfu Zhang, Hangzhou (CN); Ling Yin, Hangzhou (CN)

(21) Appl. No.: 16/005,637

(22) Filed: Jun. 11, 2018

(30) Foreign Application Priority Data
Dec. 8, 2017 (CN) 201711295714X

(51) Int. Cl. C08L 55/02; C08J 3/20

(52) U.S. Cl. CPC C08L 55/02; C08J 3/203; C08L 2205/035; C08L 2205/16; C08J 2483/04; C08J 2355/02; C08J 2469/00; C08J 2479/06; C08L 2201/08

(57) ABSTRACT

This invention discloses an anti-UV plastic for automobile interior ornaments. The anti-UV plastic for automobile interior ornaments includes PC resin, ABS resin, antioxygen, pentaerythritol stearate, inorganic filler, anti-UV fiber, organic silicon resin or modified organic silicon resin. Except maintaining the properties of ABS resin and PC resin, the anti-UV plastic for automobile interior ornaments has excellent mechanical properties and thermal properties, and can reduce the maintenance cost of automobile interior ornaments caused by UV aging. In addition, the anti-UV plastic for automobile interior ornaments owns favorable machining properties, and can be machined into automobile interior ornaments of various shapes.

### CROSS-REFERENCES TO RELATED APPLICATIONS

The present application claims priority from Chinese application No. 201711295714X filed Dec. 8, 2017 which is hereby incorporated herein by reference in its entirety.

### TECHNICAL FIELD

This invention relates to plastic technology field, in particular to an anti-UV plastic for automobile interior ornaments.

### BACKGROUND TECHNOLOGY

Automobile interior ornaments generally refer to car trunk clapboard, interior decorative plate, instrument panel, armrest, carpet, other parts and materials. Automobile interior ornaments represent automobile image and decide automobile reputation and quality as well as people's intention for automobile selection. In addition, automobile interior ornaments as auxiliary accessories undertake the functions of radiation resistance, vibration attenuation, thermal insulation, sound absorption and sound shielding. Automobile interior ornaments play a very important role for automobile comfort and durability.

Most automobile interior ornaments are made from plastic and other high polymer materials. Due to long-term exposure to sunshine, automobile interior ornaments are faced with the threat of sunlight radiation and aging more or less. UV radiation seriously affects the service life of high-molecular polymer. The environmental pollution caused by waste materials is an issue that current society cannot evade. Thus, it is very significant to research the anti-UV plastic for automobile interior ornaments in daily production and life.

The invention with the application number of 201510271996.4 discloses an alloy plastic for automobile interior ornaments. The alloy plastic for automobile interior ornaments is composed of the raw materials with the mass percentage as follows: PC resin 60-80%, ASA resin 10-20%, flexibilizer 2-6%, antioxygen 0.3-0.9%, UV absorbent 0.2-0.6%, pentaerythritol stearate 0.1-0.3%, antistatic agent 5-15%, and chain extender 0.2-0.6%.

### BRIEF SUMMARY OF THE INVENTION

The purpose of this invention is implemented through the following technical proposal:

The technical problem to be solved in this invention is to provide an anti-UV plastic for automobile interior ornaments.

The anti-UV plastic for automobile interior ornaments are made from the following raw materials: PC resin, ABS resin, antioxygen, pentaerythritol stearate, inorganic filler, anti-UV fiber, organic silicon resin or modified organic silicon resin.

To be specific, the anti-UV plastic for automobile interior ornaments is made from the materials which are prepared according to the following parts by weight: PC resin 25-30 parts, ABS resin 50-70 parts, antioxygen 1-2 parts, pentaerythritol stearate 1-3 parts, inorganic filler 0-5 parts, anti-UV fiber 15-20 parts, organic silicon resin or modified organic silicon resin 0.5-2 parts.

The antioxygen is one or several kinds among antioxygen 1098, antioxygen 1010, antioxygen 168, antioxygen 264, antioxygen T501 and antioxygen BHT.

The preparation process of the organic silicon resin is as follows:

(1) Methyl trichlorosilane and phenyl trichlorosilane whose weight is 0.3-0.4 times of weight of methyl trichlorosilane are added in the reaction vessel and mixed evenly. Then, absolute ethyl alcohol whose weight is 0.67-0.75 times of weight of methyl trichlorosilane is added and evenly mixed. Dimethyldichlorosilance whose weight is 0.6-0.7 times of weight of methyl trichlorosilane and diphenyl dichlorosilane whose weight is 0.5-0.6 times of weight of methyl trichlorosilane are added and evenly mixed to get the mixed liquid of raw materials. The temperature of feeding process system is kept at 0-2° C.

(2) Water, acetone and xylene are mixed under the environment temperature of 5-10° C. to get the reaction solvent whose volume is 2-2.5 times of mixed liquid volume of raw materials. Wherein, the volume of water is 2.8-3 times of that of absolute ethyl alcohol in Step (1). The volume ratio of acetone and xylene is 1:(10-11);

(3) The mixed liquid of raw materials is added in the reaction solvent, and the temperature rises to 50-55° C. at the speed of 2-3° C./min. The mixed liquid is stirred for 40-60 min at the speed of 170-230 rpm. Then, it is put still for 4-6 h under 20-30° C. Then, aqueous phase is discarded, and organic phase is reserved. The organic phase is washed with the sodium bicarbonate solution with mass fraction of 1-2%. Then, saturated sodium chloride is used to wash the organic phase to be neutral. The volume ratio of organic phase, sodium bicarbonate solution and saturated sodium chloride is 1:(0.5-0.7):(2-3) to get the pre-polymerization solution of organic silicon resin;

(4) Xylene is removed under the conditions of 100-120° C. and vacuum degree 0.06-0.08 MPa to gain condensed silanol. The temperature of condensed silanol rises to 150-170° C., and thermal reaction is lasted for 1.5-2 h to gain the organic silicon resin.

The preparation process of glass modified organic silicon resin is as follows:

(1) Methyl trichlorosilane and phenyl trichlorosilane whose weight is 0.3-0.4 times of weight of methyl trichlorosilane are added in the reaction vessel and mixed evenly. Then, absolute ethyl alcohol whose weight is 0.67-0.75 times of weight of methyl trichlorosilane is added and evenly mixed. Dimethyldichlorosilance whose weight is 0.6-0.7 times of weight of methyl trichlorosilane and diphenyl dichlorosilane whose weight is 0.5-0.6 times of weight of methyl trichlorosilane are added and evenly mixed to get the mixed liquid of raw materials. The temperature of feeding process system is kept at 0-2° C.

(2) Water, acetone and xylene are mixed under the environment temperature of 5-10° C. to get the reaction solvent whose volume is 2-2.5 times of mixed liquid volume of raw materials. Wherein, the volume of water is 2.8-3 times of that of absolute ethyl alcohol in Step (1). The volume ratio of acetone and xylene is 1:(10-11);

(3) The mixed liquid of raw materials is added in the reaction solvent, and the temperature rises to 50-55° C. at the speed of 2-3° C./min. The mixed liquid is stirred for 40-60 min at the speed of 170-230 rpm. Then, it is put still for 4-6 h under 20-30° C. Then, aqueous phase is discarded, and organic phase is reserved. The organic phase is washed with the sodium bicarbonate solution with mass fraction of 1-2%. Then, saturated sodium chloride is used to wash the organic phase to be neutral. The volume ratio of organic phase, sodium bicarbonate solution and saturated sodium chloride is 1:(0.5-0.7):(2-3) to get the pre-polymerization solution of organic silicon resin;

(4) The glass whose weight is 0.13-0.15 times of weight of methyl trichlorosilane is added in the organic resin prepolymer and mixed for 20-30 min at the speed of 170-230 rmp;

(5) Xylene is removed under the conditions of 100-120° C. and vacuum degree 0.06-0.08 MPa to gain condensed silanol. The temperature of condensed silanol rises to 150-170° C., and thermal reaction is lasted for 1.5-2 h to gain the glass modified organic silicon resin.

In some implementation ways of this invention, the anti-UV fiber is hydroxyl modified PBO fiber. The preparation process of hydroxyl modified PBO fiber is as follows:

(1) 4,6-diaminodiphenyl diphenol hydrochloride, 2,5-dihydroxy terephthalic acid and terephthalic acid are used as polymerization monomers, and polyphosphoric acid is used as the solvent to polymerize for 64˜90 h under 65˜185° C. to gain the pre-polymerization solution;

(2) The pre-polymerization solution gained in Step (1) is spun to get the fiber. The fiber is washed with water and dried under vacuum condition to gain the hydroxyl modified PBO fiber.

After hydroxyl group is introduced, the interface adhesiveness between PBO fiber and resin matrix is enhanced. This may be because the introduction of hydroxyl group significantly improves surface activity of fiber, changes conjugate electron cloud system in PBO and causes fiber surface activation, thus enhancing interface adhesiveness property between fiber and matrix material.

Optimally, the preparation process of hydroxyl modified PBO fiber is as follows:

(1) Preparation of prepolymerization solution: 4,6-diaminodiphenyl diphenol hydrochloride, 2,5-dihydroxy terephthalic acid, terephthalic acid and polyphosphoric acid are added in the reaction still. The molar ratio of 4,6-diaminodiphenyl diphenol hydrochloride, 2,5-dihydroxy terephthalic acid and terephthalic acid is 1:(0.05-0.5):(0.5-0.95). The addition amount of polyphosphoric acid is 5-7 times of total weight of 4,6-diaminodiphenyl diphenol hydrochloride, 2,5-dihydroxy terephthalic acid and terephthalic acid, and then they are mixed evenly. Under nitrogen protection, the temperature rises to 65-70° C. at the speed of 2-3° C./min. After stirring for 18-24 h at the speed of 170-230 rpm, hydrogen chloride gas escapes. The temperature rises to 80-100° C. at the speed of 2-3° C./min, and the solution is mixed for 16-20 h at the speed of 170-230 rpm. In this period, vacuum is pumped under the condition of vacuum degree 0.06-0.07 MPa. The generated hydrogen chloride gas is pumped out. Then, the temperature continues to rise to 130-135° C. at the speed of 2-3° C./min, and the solution is stirred for 15-20 h at the speed of 170-230 rpm. The viscosity increases. Next, the temperature continues to rise to 150-155° C. at the speed of 2-3° C./min, and the solution is stirred for 10-16 h at the speed of 170-230 rpm. The viscosity further increases. The temperature rises to 180-185° C. at the speed of 2-3° C./min, and the solution is stirred for 5-10 h at the speed of 170-230 rpm to get the prepolymerization solution.

(2) Fiber spinning and forming: the prepolymerization solution gained in Step (1) is fed into the screw extruder. The temperature in the screw is set to 170-175° C., 175-180° C. and 180-185° C. respectively. The prepolymerization solution is extruded out under the extrusion pressure of 900-1000N. Then, jet stretch and solidification molding are conducted. The spinneret plate has 16-18 holes. The diameter of spinneret plate is 0.2-0.3 mm. The distance between spinneret orifice and coagulating bath is 10-50 cm. The coagulating bath is polyphosphoric acid solution with the mass fraction of 10-12%. The temperature of coagulating bath is 20-30° C. The winding speed is 40-70 m/min. Finally, the fiber is gained. The fiber is washed with the water whose weight is 50-100 times of fiber weight, and is dried for 10-12 h under the conditions of 45-50° C. and vacuum degree 0.06-0.08 MPa to gain hydroxyl modified PBO fiber.

In some implementation ways of this invention, the anti-UV fiber is hydroxyl modified PBO/inorganic UV absorbent fiber. The preparation process of hydroxyl modified PBO/inorganic UV absorbent fiber is as follows:

(1) 4,6-diaminodiphenyl diphenol hydrochloride, 2,5-dihydroxy terephthalic acid and terephthalic acid are used as polymerization monomers, and polyphosphoric acid is used as the solvent to polymerize for 34˜44 h under 65˜100° C. The inorganic UV absorbent whose weight is 0.01-0.04 times of weight of 4,6-diaminodiphenyl diphenol hydrochloride is added to polymerize for 30˜46 h under 130˜185° C. to get the prepolymerization solution;

(2) The pre-polymerization solution gained in Step (1) is spun to get the fiber. The fiber is washed with water and dried under vacuum condition to gain the hydroxyl modified PBO/inorganic UV absorbent fiber.

After hydroxyl group is introduced in PBO fiber, the addition of inorganic UV absorbent can effectively inhibit the occurrence and proceeding of PBO photooxidation degradation reaction, delay molecular chain fracture, thus reduce decline rate of fiber molecular weight and make it keep good mechanical property.

Optimally, the preparation process of hydroxyl modified PBO/inorganic UV absorbent fiber is as follows:

(1) Preparation of prepolymerization solution: 4,6-diaminodiphenyl diphenol hydrochloride, 2,5-dihydroxy terephthalic acid, terephthalic acid and polyphosphoric acid are added in the reaction still. The molar ratio of 4,6-diaminodiphenyl diphenol hydrochloride, 2,5-dihydroxy terephthalic acid and terephthalic acid is 1:(0.05-0.5):(0.5-0.95). The addition amount of polyphosphoric acid is 5-7 times of total weight of 4,6-diaminodiphenyl diphenol hydrochloride, 2,5-dihydroxy terephthalic acid and terephthalic acid, and then they are mixed evenly. Under nitrogen protection, the temperature rises to 65-70° C. at the speed of 2-3° C./min. After stirring for 18-24 h at the speed of 170-230 rpm, hydrogen chloride gas escapes. The temperature rises to 80-100° C. at the speed of 2-3° C./min, and the solution is mixed for 16-20 h at the speed of 170-230 rpm. In this period, vacuum is pumped under the condition of vacuum degree 0.06-0.07 MPa. The generated hydrogen chloride gas is pumped out. The inorganic UV absorbent whose weight is 0.01-0.04 times of weight of 4,6-diaminodiphenyl diphenol hydrochloride is added and mixed evenly. Then, the temperature continues to rise to 130-135° C. at the speed of 2-3° C./min, and the solution is stirred for 15-20 h at the speed of 170-230 rpm. The viscosity increases. Next, the temperature continues to rise to 150-155° C. at the speed of 2-3° C./min, and the solution is stirred for 10-16 h at the speed of 170-230 rpm. The viscosity further increases. The temperature rises to 180-185° C. at the speed of 2-3° C./min, and the solution is stirred for 5-10 h at the speed of 170-230 rpm to get the prepolymerization solution.

(2) Fiber spinning and forming: the prepolymerization solution gained in Step (1) is fed into the screw extruder. The temperature in the screw is set to 170-175° C., 175-180° C. and 180-185° C. respectively. The prepolymerization solution is extruded out under the extrusion pressure of 900-1000N. Then, jet stretch and solidification molding are conducted. The spinneret plate has 16-18 holes. The diameter of spinneret plate is 0.2-0.3 mm. The distance between spinneret orifice and coagulating bath is 10-50 cm. The coagulating bath is polyphosphoric acid solution with the mass fraction of 10-12%. The temperature of coagulating bath is 20-30° C. The winding speed is 40-70 m/min. Finally, the fiber is gained. The fiber is washed with the water whose weight is 50-100 times of fiber weight, and is dried for 10-12 h under the conditions of 45-50° C. and vacuum degree 0.06-0.08 MPa to gain the hydroxyl modified PBO/inorganic UV absorbent fiber.

The inorganic UV absorbent is one or the combination of titanium dioxide, zinc oxide and Zr doped zinc oxide. Optimally, the inorganic UV absorbent is the mixture of titanium dioxide and Zr doped zinc oxide with the mass ratio of 1:(2-3).

The preparation process of Zr doped zinc oxide is as follows: zinc nitrate water solution with the molar concentration of 0.4-0.5 mol/L is prepared, and cetyl trimethyl ammonium bromide is added. The solid-to-liquid ratio of cetyl trimethyl ammonium bromide and zinc nitrate water solution is 0.008-0.009 g/mL, and they are mixed evenly to get mixed liquid A. Sodium hydroxide water liquid with the molar concentration of 1-2 mol/L is added under the stirring condition of 170-230 rpm. The volume ratio of mixed liquid A and sodium hydroxide water liquid is 1:(1-1.2), and they are stirred for 20-30 min at the speed of 170-230 rpm to get the material I. Zirconium dichloride hydrate and water are mixed at the mass ratio of 1:(18-20). Then, sodium hydroxide whose weight is 1.7-1.9 times of weight of zirconium dichloride hydrate is added and reacts for 30-40 min at the speed of 170-230 rpm to get the reaction liquid. The reaction liquid is centrifuged for 15-25 min at the speed of 2000-3000 rpm, and the solid at the bottom is collected to get the material II. The material I and the material II are mixed and heated to 140-150° C. After thermal insulation for 30-40 min, the mixture of material I and material II is cooled to 20-25° C., and the reaction product is gathered. After the reaction product is washed respectively with the water whose weight is 50-100 times of reaction product weight and absolute ethyl alcohol whose weight is 40-70 times of reaction product weight, it is dried for 8-12 h under the condition of 45-50° C. and vacuum degree 0.06-0.08 MPa, and smashed to particles with the grain size of 100-500 nm to gain the Zr doped zinc oxide. Through doping transition metal ion, defects can be introduced in the lattice in zinc oxide semiconductor, and the crystallinity is changed. Meanwhile, the shielding effect of UV is enhanced.

The inorganic filler is one or several kinds among talcum powder, mica powder, kaolin, pyrophyllite powder, calcium carbonate, wollastonite, calcium sulfate and carbon black.

The second technical problem to be solved by this invention is to provide the method to prepare the anti-UV plastic for automobile interior ornaments.

The method to prepare the anti-UV plastic for automobile interior ornaments includes the following steps:

S1 PC resin and ABS resin are dried respectively for 3˜5 h under 80˜85° C.;

S2 PC resin, ABS resin, antioxygen, pentaerythritol stearate, inorganic filler, anti-UV fiber, organic silicon resin or modified organic silicon resin are weighed according to the formula, and mixed for 5-10 min at the speed of 3000-5000 rpm to get the mixture;

S3 The mixture is put in the extruder to extrude out. The temperature of feeding segment of the extruder is 180˜190° C. The temperature of mixing segment is 230˜240° C. The temperature of machine head is 200˜210° C. The revolving speed of main machine is 80˜100 rpm. Then, cooling and cutting into particles are conducted to get the anti-UV plastic for automobile interior ornaments.

Except maintaining the properties of ABS resin and PC resin, the anti-UV plastic for automobile interior ornaments has excellent mechanical properties and thermal properties, and can reduce the maintenance cost of automobile interior ornaments caused by UV aging. In addition, the anti-UV plastic for automobile interior ornaments owns favorable machining properties, and can be machined into automobile interior ornaments of various shapes.

### DETAILED DESCRIPTION OF THE INVENTION

Introduction to various raw materials and instruments in the implementation examples:

PC resin, purchased from Bayer, type number 1803

ABS resin, purchased from Taiwan Qimei, type number PA-709s

Antioxygen 1010, CAS No.: 6683-19-8, purchased from BASF China

Pentaerythritol stearate, CAS No.: 115-83-3, purchased from TCI (Shanghai) Chemical Industry Co., Ltd.

Pyrophyllite powder, purchased from Lingshou Qianfu Mineral Processing Plant, 500.

4,6-diaminodiphenyl diphenol hydrochloride, CAS No.: 16523-31-2, purchased from TCI (Shanghai) Chemical Industry Co., Ltd.

Terephthalic acid, CAS No.: 100-21-0, purchased from Shanghai Future Industrial Co., Ltd.

Polyphosphoric acid, purchased from Shanghai Meryer Chemical Technology Co., Ltd.; the content of phosphorus pentoxide 84-85%

2,5-dihydroxy terephthalic acid, CAS No.: 610-92-4, purchased from Shangjai Chemsoon Technology Co., Ltd.

Methyl trichlorosilane, CAS No.: 75-79-6, purchased from Shandong Xiaoye Chemical Co., Ltd.

Phenyl trichlorosilane, CAS No.: 98-13-5, purchased from J&K Scientific Co., Ltd.

Dimethyldichlorosilance, CAS No.: 75-78-5, purchased from Shanghai Worldyang Chemical Co., Limited

Diphenyl dichlorosilane, CAS No.: 80-10-4, purchased from J&K Scientific Co., Ltd.

Titanium dioxide, rutile titanium dioxide from Shandong Jiechen Chemical Co., Ltd. is smashed to the particles with grain size of 100 nm

Zinc oxide, zinc oxide from Zhengzhou Runjia Chenical Products Co., Ltd. is smashed to the particles with grain size of 100 nm

Glass, purchased from Lingshou Qianfu Mineral Processing Plant, 500

Zirconium dichloride hydrate, CAS No.: 15461-27-5, purchased from Meryer Chemical Technology Co., Ltd.

Cetyl trimethyl ammonium bromide, CAS No.: 57-09-0, purchased from Shanghai Aladdin Biochemical Technology Co., Ltd.

### Implementation Example 1

The anti-UV plastic for automobile interior ornaments is made from the materials which are prepared according to the following parts by weight: PC resin 30 parts, ABS resin 70 parts, antioxygen 1010 2 parts, pentaerythritol stearate 3 parts, pyrophyllite powder 5 parts, PBO fiber (length 0.6 mm) 20 parts, organic silicon resin 2 parts.

The preparation process of PBO fiber is as follows:

(1) Preparation of prepolymerization solution: 4,6-diaminodiphenyl diphenol hydrochloride, terephthalic acid and polyphosphoric acid are added in the reaction still. The molar ratio of 4,6-diaminodiphenyl diphenol hydrochloride and terephthalic acid is 1:1. The addition amount of polyphosphoric acid is 5 times of total weight of 4,6-diaminodiphenyl diphenol hydrochloride and terephthalic acid, and then they are mixed evenly. Under nitrogen protection, the temperature rises to 65° C. at the speed of 2° C./min. After stirring for 24 h at the speed of 170 rpm, hydrogen chloride gas escapes. The temperature rises to 80° C. at the speed of 2° C./min, and the solution is mixed for 20 h at the speed of 170 rpm. In this period, vacuum is pumped under the condition of vacuum degree 0.06 MPa. The generated hydrogen chloride gas is pumped out. Then, the temperature continues to rise to 130° C. at the speed of 2° C./min, and the solution is stirred for 20 h at the speed of 170 rpm. The viscosity increases. Next, the temperature continues to rise to 150° C. at the speed of 2° C./min, and the solution is stirred for 16 h at the speed of 170 rpm. The viscosity further increases. The temperature rises to 180° C. at the speed of 2° C./min, and the solution is stirred for 10 h at the speed of 170 rpm to get the prepolymerization solution.

(2) Fiber spinning and forming: the prepolymerization solution gained in Step (1) is fed into the single screw extruder. The temperature in the screw is set to 170° C., 175° C. and 180° C. respectively. The prepolymerization solution is extruded out under the extrusion pressure of 900N. Then, jet stretch and solidification molding are conducted. The spinneret plate has 18 holes. The diameter of spinneret plate is 0.3 mm. The distance between spinneret orifice and coagulating bath is 35 cm. The coagulating bath is polyphosphoric acid solution with the mass fraction of 10%. The temperature of coagulating bath is 25° C. The winding speed is 50 m/min. Finally, the fiber is gained. The fiber is washed with the water whose weight is 80 times of fiber weight, and is dried for 12 h under the conditions of 45° C. and vacuum degree 0.07 MPa to gain the PBO fiber. The PBO fiber is cut to the length of 0.6 mm.

The preparation process of the organic silicon resin is

(1) Methyl trichlorosilane and phenyl trichlorosilane whose weight is 0.3 times of weight of methyl trichlorosilane are added in the reaction vessel and mixed evenly. Then, absolute ethyl alcohol whose weight is 0.67 times of weight of methyl trichlorosilane is added and evenly mixed. Dimethyldichlorosilance whose weight is 0.6 times of weight of methyl trichlorosilane and diphenyl dichlorosilane whose weight is 0.5 times of weight of methyl trichlorosilane are added and evenly mixed to get the mixed liquid of raw materials. The temperature of feeding process system is kept at 0° C.

(2) Water, acetone and xylene are mixed under the environment temperature of 5° C. to get the reaction solvent whose volume is 2 times of mixed liquid volume of raw materials. Wherein, the volume of water is 2.8 times of that of absolute ethyl alcohol in Step (1). The volume ratio of acetone and xylene is 1:10;

(3) The mixed liquid of raw materials is added in the reaction solvent, and the temperature rises to 50° C. at the speed of 2° C./min. The mixed liquid is stirred for 40 min at the speed of 170 rpm. Then, it is put still for 4 h under 20° C. Then, aqueous phase is discarded, and organic phase is reserved. The organic phase is washed with the sodium bicarbonate solution with mass fraction of 1%. Then, saturated sodium chloride is used to wash the organic phase to be neutral. The volume ratio of organic phase, sodium bicarbonate solution and saturated sodium chloride is 1:0.5:2 to get the pre-polymerization solution of organic silicon resin;

(4) Xylene is removed under the conditions of 100° C. and vacuum degree 0.06 MPa to gain condensed silanol. The temperature of condensed silanol rises to 150° C., and thermal reaction is lasted for 1.5 h to gain the glass modified organic silicon resin.

The method to prepare the anti-UV plastic for automobile interior ornaments includes the following steps:

S1 PC resin and ABS resin are dried respectively for 4 h under 85° C.;

S2 PC resin, ABS resin, antioxygen 1010, pentaerythritol stearate, pyrophyllite powder, PBO fiber and organic silicon resin are weighed according to the formula, and mixed for 8 min at the speed of 3000 rpm to get the mixture;

S3 The mixture is put in the extruder to extrude out. The temperature of feeding segment of the extruder is 190° C. The temperature of mixing segment is 240° C. The temperature of machine head is 210° C. The revolving speed of main machine is 80 rpm. Then, cooling and cutting into cylindrical particles with the diameter of 3 mm and length of 2 mm are conducted to get the anti-UV plastic for automobile interior ornaments.

### Implementation Example 2

The anti-UV plastic for automobile interior ornaments is made from the materials which are prepared according to the following parts by weight: PC resin 30 parts, ABS resin 70 parts, antioxygen 1010 2 parts, pentaerythritol stearate 3 parts, pyrophyllite powder 5 parts, PBO fiber (length 0.6 mm) 20 parts, glass modified organic silicon resin 2 parts.

The preparation process of PBO fiber is as follows:

(1) Preparation of prepolymerization solution: 4,6-diaminodiphenyl diphenol hydrochloride, terephthalic acid and polyphosphoric acid are added in the reaction still. The molar ratio of 4,6-diaminodiphenyl diphenol hydrochloride and terephthalic acid is 1:1. The addition amount of polyphosphoric acid is 5 times of total weight of 4,6-diaminodiphenyl diphenol hydrochloride and terephthalic acid, and then they are mixed evenly. Under nitrogen protection, the temperature rises to 65° C. at the speed of 2° C./min. After stirring for 24 h at the speed of 170 rpm, hydrogen chloride gas escapes. The temperature rises to 80° C. at the speed of 2° C./min, and the solution is mixed for 20 h at the speed of 170 rpm. In this period, vacuum is pumped under the condition of vacuum degree 0.06 MPa. The generated hydrogen chloride gas is pumped out. Then, the temperature continues to rise to 130° C. at the speed of 2° C./min, and the solution is stirred for 20 h at the speed of 170 rpm. The viscosity increases. Next, the temperature continues to rise to 150° C. at the speed of 2° C./min, and the solution is stirred for 16 h at the speed of 170 rpm. The viscosity further increases. The temperature rises to 180° C. at the speed of 2° C./min, and the solution is stirred for 10 h at the speed of 170 rpm to get the prepolymerization solution.

(2) Fiber spinning and forming: the prepolymerization solution gained in Step (1) is fed into the single screw extruder. The temperature in the screw is set to 170° C., 175° C. and 180° C. respectively. The prepolymerization solution is extruded out under the extrusion pressure of 900N. Then, jet stretch and solidification molding are conducted. The spinneret plate has 18 holes. The diameter of spinneret plate is 0.3 mm. The distance between spinneret orifice and coagulating bath is 35 cm. The coagulating bath is polyphosphoric acid solution with the mass fraction of 10%. The temperature of coagulating bath is 25° C. The winding speed is 50 m/min. Finally, the fiber is gained. The fiber is washed with the water whose weight is 80 times of fiber weight, and is dried for 12 h under the conditions of 45° C. and vacuum degree 0.07 MPa to gain the PBO fiber. The PBO fiber is cut to the length of 0.6 mm.

The preparation process of glass modified organic silicon resin is as follows:

(1) Methyl trichlorosilane and phenyl trichlorosilane whose weight is 0.3 times of weight of methyl trichlorosilane are added in the reaction vessel and mixed evenly. Then, absolute ethyl alcohol whose weight is 0.67 times of weight of methyl trichlorosilane is added and evenly mixed. Dimethyldichlorosilance whose weight is 0.6 times of weight of methyl trichlorosilane and diphenyl dichlorosilane whose weight is 0.5 times of weight of methyl trichlorosilane are added and evenly mixed to get the mixed liquid of raw materials. The temperature of feeding process system is kept at 0° C.

(2) Water, acetone and xylene are mixed under the environment temperature of 5° C. to get the reaction solvent whose volume is 2 times of mixed liquid volume of raw materials. Wherein, the volume of water is 2.8 times of that of absolute ethyl alcohol in Step (1). The volume ratio of acetone and xylene is 1:10;

(3) The mixed liquid of raw materials is added in the reaction solvent, and the temperature rises to 50° C. at the speed of 2° C./min. The mixed liquid is stirred for 40 min at the speed of 170 rpm. Then, it is put still for 4 h under 20° C. Then, aqueous phase is discarded, and organic phase is reserved. The organic phase is washed with the sodium bicarbonate solution with mass fraction of 1%. Then, saturated sodium chloride is used to wash the organic phase to be neutral. The volume ratio of organic phase, sodium bicarbonate solution and saturated sodium chloride is 1:0.5:2 to get the pre-polymerization solution of organic silicon resin;

(4) The glass whose weight is 0.13 times of weight of methyl trichlorosilane is added in the organic resin prepolymer and mixed for 20 min at the speed of 170 rmp;

(5) Xylene is removed under the conditions of 100° C. and vacuum degree 0.06 MPa to gain condensed silanol. The temperature of condensed silanol rises to 150° C., and thermal reaction is lasted for 1.5 h to gain the glass modified organic silicon resin.

The method to prepare the anti-UV plastic for automobile interior ornaments includes the following steps:

S1 PC resin and ABS resin are dried respectively for 4 h under 85° C.;

S2 PC resin, ABS resin, antioxygen 1010, pentaerythritol stearate, pyrophyllite powder, PBO fiber and glass modified organic silicon resin are weighed according to the formula, and mixed for 8 min at the speed of 3000 rpm to get the mixture;

S3 The mixture is put in the extruder to extrude out. The temperature of feeding segment of the extruder is 190° C. The temperature of mixing segment is 240° C. The temperature of machine head is 210° C. The revolving speed of main machine is 80 rpm. Then, cooling and cutting into cylindrical particles with the diameter of 3 mm and length of 2 mm are conducted to get the anti-UV plastic for automobile interior ornaments.

### Implementation Example 3

The anti-UV plastic for automobile interior ornaments is made from the materials which are prepared according to the following parts by weight: PC resin 30 parts, ABS resin 70 parts, antioxygen 1010 2 parts, pentaerythritol stearate 3 parts, pyrophyllite powder 5 parts, PBO fiber (length 0.6 mm) 20 parts, organic silicon resin 2 parts.

The preparation process of hydroxyl modified PBO fiber is as follows:

(1) Preparation of prepolymerization solution: 4,6-diaminodiphenyl diphenol hydrochloride, 2,5-dihydroxy terephthalic acid, terephthalic acid and polyphosphoric acid are added in the reaction still. The molar ratio of 4,6-diaminodiphenyl diphenol hydrochloride, 2,5-dihydroxy terephthalic acid and terephthalic acid is 1:0.35:0.65. The addition amount of polyphosphoric acid is 5 times of total weight of 4,6-diaminodiphenyl diphenol hydrochloride, 2,5-dihydroxy terephthalic acid and terephthalic acid, and then they are mixed evenly. Under nitrogen protection, the temperature rises to 65° C. at the speed of 2° C./min. After stirring for 24 h at the speed of 170 rpm, hydrogen chloride gas escapes. The temperature rises to 80° C. at the speed of 2° C./min, and the solution is mixed for 20 h at the speed of 170 rpm. In this period, vacuum is pumped under the condition of vacuum degree 0.06 MPa. The generated hydrogen chloride gas is pumped out. Then, the temperature continues to rise to 130° C. at the speed of 2° C./min, and the solution is stirred for 20 h at the speed of 170 rpm. The viscosity increases. Next, the temperature continues to rise to 150° C. at the speed of 2° C./min, and the solution is stirred for 16 h at the speed of 170 rpm. The viscosity further increases. The temperature rises to 180° C. at the speed of 2° C./min, and the solution is stirred for 10 h at the speed of 170 rpm to get the prepolymerization solution.

(2) Fiber spinning and forming: the prepolymerization solution gained in Step (1) is fed into the single screw extruder. The temperature in the screw is set to 170° C., 175° C. and 180° C. respectively. The prepolymerization solution is extruded out under the extrusion pressure of 900 N. Then, jet stretch and solidification molding are conducted. The spinneret plate has 18 holes. The diameter of spinneret plate is 0.3 mm. The distance between spinneret orifice and coagulating bath is 35 cm. The coagulating bath is polyphosphoric acid solution with the mass fraction of 10%. The temperature of coagulating bath is 25° C. The winding speed is 50 m/min. Finally, the fiber is gained. The fiber is washed with the water whose weight is 80 times of fiber weight, and is dried for 12 h under the conditions of 45° C. and vacuum degree 0.07 MPa to gain the hydroxyl modified PBO fiber. The hydroxyl modified PBO fiber is cut to the length of 0.6 mm.

The preparation process of glass modified organic silicon resin is as follows:

(1) Methyl trichlorosilane and phenyl trichlorosilane whose weight is 0.3 times of weight of methyl trichlorosilane are added in the reaction vessel and mixed evenly. Then, absolute ethyl alcohol whose weight is 0.67 times of weight of methyl trichlorosilane is added and evenly mixed. Dimethyldichlorosilance whose weight is 0.6 times of weight of methyl trichlorosilane and diphenyl dichlorosilane whose weight is 0.5 times of weight of methyl trichlorosilane are added and evenly mixed to get the mixed liquid of raw materials. The temperature of feeding process system is kept at 0° C.

(2) Water, acetone and xylene are mixed under the environment temperature of 5° C. to get the reaction solvent whose volume is 2 times of mixed liquid volume of raw materials. Wherein, the volume of water is 2.8 times of that of absolute ethyl alcohol in Step (1). The volume ratio of acetone and xylene is 1:10;

(3) The mixed liquid of raw materials is added in the reaction solvent, and the temperature rises to 50° C. at the speed of 2° C./min. The mixed liquid is stirred for 40 min at the speed of 170 rpm. Then, it is put still for 4 h under 20° C. Then, aqueous phase is discarded, and organic phase is reserved. The organic phase is washed with the sodium bicarbonate solution with mass fraction of 1%. Then, saturated sodium chloride is used to wash the organic phase to be neutral. The volume ratio of organic phase, sodium bicarbonate solution and saturated sodium chloride is 1:0.5:2 to get the pre-polymerization solution of organic silicon resin;

(4) The glass whose weight is 0.13 times of weight of methyl trichlorosilane is added in the organic resin prepolymer and mixed for 20 min at the speed of 170 rmp;

(5) Xylene is removed under the conditions of 100° C. and vacuum degree 0.06 MPa to gain condensed silanol. The temperature of condensed silanol rises to 150° C., and thermal reaction is lasted for 1.5 h to gain the glass modified organic silicon resin.

The method to prepare the anti-UV plastic for automobile interior ornaments includes the following steps:

S1 PC resin and ABS resin are dried respectively for 4 h under 85° C.;

S2 PC resin, ABS resin, antioxygen 1010, pentaerythritol stearate, pyrophyllite powder, hydroxyl modified PBO fiber and glass modified organic silicon resin are weighed according to the formula, and mixed for 8 min at the speed of 3000 rpm to get the mixture;

S3 The mixture is put in the extruder to extrude out. The temperature of feeding segment of the extruder is 190° C. The temperature of mixing segment is 240° C. The temperature of machine head is 210° C. The revolving speed of main machine is 80 rpm. Then, cooling and cutting into cylindrical particles with the diameter of 3 mm and length of 2 mm are conducted to get the anti-UV plastic for automobile interior ornaments.

### Implementation Example 4

The anti-UV plastic for automobile interior ornaments is made from the materials which are prepared according to the following parts by weight: PC resin 30 parts, ABS resin 70 parts, antioxygen 1010 2 parts, pentaerythritol stearate 3 parts, pyrophyllite powder 5 parts, hydroxyl modified PBO/titanium dioxide fiber (length 0.6 mm) 20 parts, glass modified organic silicon resin 2 parts.

The preparation process of hydroxyl modified PBO/titanium dioxide fiber is as follows:

(1) Preparation of prepolymerization solution: 4,6-diaminodiphenyl diphenol hydrochloride, 2,5-dihydroxy terephthalic acid, terephthalic acid and polyphosphoric acid are added in the reaction still. The molar ratio of 4,6-diaminodiphenyl diphenol hydrochloride, 2,5-dihydroxy terephthalic acid and terephthalic acid is 1:0.35:0.65. The addition amount of polyphosphoric acid is 5 times of total weight of 4,6-diaminodiphenyl diphenol hydrochloride, 2,5-dihydroxy terephthalic acid and terephthalic acid, and then they are mixed evenly. Under nitrogen protection, the temperature rises to 65° C. at the speed of 2° C./min. After stirring for 24 h at the speed of 170 rpm, hydrogen chloride gas escapes. The temperature rises to 80° C. at the speed of 2° C./min, and the solution is mixed for 20 h at the speed of 170 rpm. In this period, vacuum is pumped under the condition of vacuum degree 0.06 MPa. The generated hydrogen chloride gas is pumped out. Titanium dioxide whose weight is 0.04 times of 4,6-diaminodiphenyl diphenol hydrochloride is added and mixed evenly. Then, the temperature continues to rise to 130° C. at the speed of 2° C./min, and the solution is stirred for 20 h at the speed of 170 rpm. The viscosity increases. Next, the temperature continues to rise to 150° C. at the speed of 2° C./min, and the solution is stirred for 16 h at the speed of 170 rpm. The viscosity further increases. The temperature rises to 180° C. at the speed of 2° C./min, and the solution is stirred for 10 h at the speed of 170 rpm to get the prepolymerization solution.

(2) Fiber spinning and forming: the prepolymerization solution gained in Step (1) is fed into the single screw extruder. The temperature in the screw is set to 170° C., 175° C. and 180° C. respectively. The prepolymerization solution is extruded out under the extrusion pressure of 900N. Then, jet stretch and solidification molding are conducted. The spinneret plate has 18 holes. The diameter of spinneret plate is 0.3 mm. The distance between spinneret orifice and coagulating bath is 35 cm. The coagulating bath is polyphosphoric acid solution with the mass fraction of 10%. The temperature of coagulating bath is 25° C. The winding speed is 50 m/min. Finally, the fiber is gained. The fiber is washed with the water whose weight is 80 times of fiber weight, and is dried for 12 h under the conditions of 45° C. and vacuum degree 0.07 MPa to gain the hydroxyl modified PBO/titanium dioxide fiber. The hydroxyl modified PBO/titanium dioxide fiber is cut to the length of 0.6 mm.

The preparation process of glass modified organic silicon resin is as follows:

(1) Methyl trichlorosilane and phenyl trichlorosilane whose weight is 0.3 times of weight of methyl trichlorosilane are added in the reaction vessel and mixed evenly. Then, absolute ethyl alcohol whose weight is 0.67 times of weight of methyl trichlorosilane is added and evenly mixed. Dimethyldichlorosilance whose weight is 0.6 times of weight of methyl trichlorosilane and diphenyl dichlorosilane whose weight is 0.5 times of weight of methyl trichlorosilane are added and evenly mixed to get the mixed liquid of raw materials. The temperature of feeding process system is kept at 0° C.

(2) Water, acetone and xylene are mixed under the environment temperature of 5° C. to get the reaction solvent whose volume is 2 times of mixed liquid volume of raw materials. Wherein, the volume of water is 2.8 times of that of absolute ethyl alcohol in Step (1). The volume ratio of acetone and xylene is 1:10;

(3) The mixed liquid of raw materials is added in the reaction solvent, and the temperature rises to 50° C. at the speed of 2° C./min. The mixed liquid is stirred for 40 min at the speed of 170 rpm. Then, it is put still for 4 h under 20° C. Then, aqueous phase is discarded, and organic phase is reserved. The organic phase is washed with the sodium bicarbonate solution with mass fraction of 1%. Then, saturated sodium chloride is used to wash the organic phase to be neutral. The volume ratio of organic phase, sodium bicarbonate solution and saturated sodium chloride is 1:0.5:2 to get the pre-polymerization solution of organic silicon resin;

(4) The glass whose weight is 0.13 times of weight of methyl trichlorosilane is added in the organic resin prepolymer and mixed for 20 min at the speed of 170 rmp;

(5) Xylene is removed under the conditions of 100° C. and vacuum degree 0.06 MPa to gain condensed silanol. The temperature of condensed silanol rises to 150° C., and thermal reaction is lasted for 1.5 h to gain the glass modified organic silicon resin.

The method to prepare the anti-UV plastic for automobile interior ornaments includes the following steps:

S1 PC resin and ABS resin are dried respectively for 4 h under 85° C.;

S2 PC resin, ABS resin, antioxygen 1010, pentaerythritol stearate, pyrophyllite powder, hydroxyl modified PBO/titanium dioxide fiber and glass modified organic silicon resin are weighed according to the formula, and mixed for 8 min at the speed of 3000 rpm to get the mixture;

S3 The mixture is put in the extruder to extrude out. The temperature of feeding segment of the extruder is 190° C. The temperature of mixing segment is 240° C. The temperature of machine head is 210° C. The revolving speed of main machine is 80 rpm. Then, cooling and cutting into cylindrical particles with the diameter of 3 mm and length of 2 mm are conducted to get the anti-UV plastic for automobile interior ornaments.

Scratch resistance is tested for implementation example 4 by referring to ASTM G 171-03. It is found that, obvious scratch can be seen with naked eyes, and it is rough and not smooth. Besides, peeling is very obvious.

### Implementation Example 5

The anti-UV plastic for automobile interior ornaments is made from the materials which are prepared according to the following parts by weight: PC resin 30 parts, ABS resin 70 parts, antioxygen 1010 2 parts, pentaerythritol stearate 3 parts, pyrophyllite powder 5 parts, hydroxyl modified PBO/Zr doped zinc oxide fiber (length 0.6 mm) 20 parts, glass modified organic silicon resin 2 parts.

The preparation process of hydroxyl modified PBO/Zr doped zinc oxide fiber is as follows:

(1) Preparation of prepolymerization solution: 4,6-diaminodiphenyl diphenol hydrochloride, 2,5-dihydroxy terephthalic acid, terephthalic acid and polyphosphoric acid are added in the reaction still. The molar ratio of 4,6-diaminodiphenyl diphenol hydrochloride, 2,5-dihydroxy terephthalic acid and terephthalic acid is 1:0.35:0.65. The addition amount of polyphosphoric acid is 5 times of total weight of 4,6-diaminodiphenyl diphenol hydrochloride, 2,5-dihydroxy terephthalic acid and terephthalic acid, and then they are mixed evenly. Under nitrogen protection, the temperature rises to 65° C. at the speed of 2° C./min. After stirring for 24 h at the speed of 170 rpm, hydrogen chloride gas escapes. The temperature rises to 80° C. at the speed of 2° C./min, and the solution is mixed for 20 h at the speed of 170 rpm. In this period, vacuum is pumped under the condition of vacuum degree 0.06 MPa. The generated hydrogen chloride gas is pumped out. Zr doped zinc oxide whose weight is 0.04 times of 4,6-diaminodiphenyl diphenol hydrochloride is added and mixed evenly. Then, the temperature continues to rise to 130° C. at the speed of 2° C./min, and the solution is stirred for 20 h at the speed of 170 rpm. The viscosity increases. Next, the temperature continues to rise to 150° C. at the speed of 2° C./min, and the solution is stirred for 16 h at the speed of 170 rpm. The viscosity further increases. The temperature rises to 180° C. at the speed of 2° C./min, and the solution is stirred for 10 h at the speed of 170 rpm to get the prepolymerization solution.

(2) Fiber spinning and forming: the prepolymerization solution gained in Step (1) is fed into the single screw extruder. The temperature in the screw is set to 170° C., 175° C. and 180° C. respectively. The prepolymerization solution is extruded out under the extrusion pressure of 900N. Then, jet stretch and solidification molding are conducted. The spinneret plate has 18 holes. The diameter of spinneret plate is 0.3 mm. The distance between spinneret orifice and coagulating bath is 35 cm. The coagulating bath is polyphosphoric acid solution with the mass fraction of 10%. The temperature of coagulating bath is 25° C. The winding speed is 50 m/min. Finally, the fiber is gained. The fiber is washed with the water whose weight is 80 times of fiber weight, and is dried for 12 h under the conditions of 45° C. and vacuum degree 0.07 MPa to gain the hydroxyl modified PBO/Zr doped zinc oxide fiber. The hydroxyl modified PBO/Zr doped zinc oxide fiber is cut to the length of 0.6 mm.

The preparation process of glass modified organic silicon resin is as follows:

(1) Methyl trichlorosilane and phenyl trichlorosilane whose weight is 0.3 times of weight of methyl trichlorosilane are added in the reaction vessel and mixed evenly. Then, absolute ethyl alcohol whose weight is 0.67 times of weight of methyl trichlorosilane is added and evenly mixed. Dimethyldichlorosilance whose weight is 0.6 times of weight of methyl trichlorosilane and diphenyl dichlorosilane whose weight is 0.5 times of weight of methyl trichlorosilane are added and evenly mixed to get the mixed liquid of raw materials. The temperature of feeding process system is kept at 0° C.

(2) Water, acetone and xylene are mixed under the environment temperature of 5° C. to get the reaction solvent whose volume is 2 times of mixed liquid volume of raw materials. Wherein, the volume of water is 2.8 times of that of absolute ethyl alcohol in Step (1). The volume ratio of acetone and xylene is 1:10;

(3) The mixed liquid of raw materials is added in the reaction solvent, and the temperature rises to 50° C. at the speed of 2° C./min. The mixed liquid is stirred for 40 min at the speed of 170 rpm. Then, it is put still for 4 h under 20° C. Then, aqueous phase is discarded, and organic phase is reserved. The organic phase is washed with the sodium bicarbonate solution with mass fraction of 1%. Then, saturated sodium chloride is used to wash the organic phase to be neutral. The volume ratio of organic phase, sodium bicarbonate solution and saturated sodium chloride is 1:0.5:2 to get the pre-polymerization solution of organic silicon resin;

(4) The glass whose weight is 0.13 times of weight of methyl trichlorosilane is added in the organic resin prepolymer and mixed for 20 min at the speed of 170 rmp;

(5) Xylene is removed under the conditions of 100° C. and vacuum degree 0.06 MPa to gain condensed silanol. The temperature of condensed silanol rises to 150° C., and thermal reaction is lasted for 1.5 h to gain the glass modified organic silicon resin.

The preparation process of Zr doped zinc oxide is as follows: zinc nitrate water solution with the molar concentration of 0.5 mol/L is prepared, and cetyl trimethyl ammonium bromide is added. The solid-to-liquid ratio of cetyl trimethyl ammonium bromide and zinc nitrate water solution is 0.009 g/mL, and they are mixed evenly to get mixed liquid A. Sodium hydroxide water liquid with the molar concentration of 2 mol/L is added under the stirring condition of 230 rpm. The volume ratio of mixed liquid A and sodium hydroxide water liquid is 1:1.2, and they are stirred for 30 min at the speed of 230 rpm to get the material I. Zirconium dichloride hydrate and water are mixed at the mass ratio of 1:20. Then, sodium hydroxide whose weight is 1.9 times of weight of zirconium dichloride hydrate is added and reacts for 40 min at the speed of 230 rpm to get the reaction liquid. The reaction liquid is centrifuged for 25 min at the speed of 3000 rpm, and the solid at the bottom is collected to get the material II. The material I and the material II are mixed and heated to 150° C. After thermal insulation for 40 min, the mixture of material I and material II is cooled to 25° C., and the reaction product is gathered. After the reaction product is washed respectively with the water whose weight is 100 times of reaction product weight and absolute ethyl alcohol whose weight is 70 times of reaction product weight, it is dried for 12 h under the condition of 50° C. and vacuum degree 0.08 MPa, and smashed to particles with the grain size of 100 nm to gain the Zr doped zinc oxide.

The method to prepare the anti-UV plastic for automobile interior ornaments includes the following steps:

S1 PC resin and ABS resin are dried respectively for 4 h under 85° C.;

S2 PC resin, ABS resin, antioxygen 1010, pentaerythritol stearate, pyrophyllite powder, hydroxyl modified PBO/Zr doped zinc oxide fiber and glass modified organic silicon resin are weighed according to the formula, and mixed for 8 min at the speed of 3000 rpm to get the mixture;

S3 The mixture is put in the extruder to extrude out. The temperature of feeding segment of the extruder is 190° C. The temperature of mixing segment is 240° C. The temperature of machine head is 210° C. The revolving speed of main machine is 80 rpm. Then, cooling and cutting into cylindrical particles with the diameter of 3 mm and length of 2 mm are conducted to get the anti-UV plastic for automobile interior ornaments.

Scratch resistance is tested for implementation example 5 by referring to ASTM G 171-03. It is found that, no obvious scratch can be seen with naked eyes, and the obvious scratch can be seen when the magnifying lens is magnified for 300 times.

### Implementation Example 6

The anti-UV plastic for automobile interior ornaments is made from the materials which are prepared according to the following parts by weight: PC resin 30 parts, ABS resin 70 parts, antioxygen 1010 2 parts, pentaerythritol stearate 3 parts, pyrophyllite powder 5 parts, hydroxyl modified PBO/titanium dioxide/Zr doped zinc oxide fiber (length 0.6 mm) 20 parts, glass modified organic silicon resin 2 parts.

The preparation process of hydroxyl modified PBO/titanium dioxide/Zr doped zinc oxide fiber is as follows:

(1) Preparation of prepolymerization solution: 4,6-diaminodiphenyl diphenol hydrochloride, 2,5-dihydroxy terephthalic acid, terephthalic acid and polyphosphoric acid are added in the reaction still. The molar ratio of 4,6-diaminodiphenyl diphenol hydrochloride, 2,5-dihydroxy terephthalic acid and terephthalic acid is 1:0.35:0.65. The addition amount of polyphosphoric acid is 5 times of total weight of 4,6-diaminodiphenyl diphenol hydrochloride, 2,5-dihydroxy terephthalic acid and terephthalic acid, and then they are mixed evenly. Under nitrogen protection, the temperature rises to 65° C. at the speed of 2° C./min. After stirring for 24 h at the speed of 170 rpm, hydrogen chloride gas escapes. The temperature rises to 80° C. at the speed of 2° C./min, and the solution is mixed for 20 h at the speed of 170 rpm. In this period, vacuum is pumped under the condition of vacuum degree 0.06 MPa. The generated hydrogen chloride gas is pumped out. Inorganic UV absorbent whose weight is 0.04 times of 4,6-diaminodiphenyl diphenol hydrochloride is added. The inorganic UV absorbent is the mixture of titanium dioxide and Zr doped zinc oxide with the mass ratio of 1:2. Then, the temperature continues to rise to 130° C. at the speed of 2° C./min, and the solution is stirred for 20 h at the speed of 170 rpm. The viscosity increases. Next, the temperature continues to rise to 150° C. at the speed of 2° C./min, and the solution is stirred for 16 h at the speed of 170 rpm. The viscosity further increases. The temperature rises to 180° C. at the speed of 2° C./min, and the solution is stirred for 10 h at the speed of 170 rpm to get the prepolymerization solution.

(2) Fiber spinning and forming: the prepolymerization solution gained in Step (1) is fed into the single screw extruder. The temperature in the screw is set to 170° C., 175° C. and 180° C. respectively. The prepolymerization solution is extruded out under the extrusion pressure of 900N. Then, jet stretch and solidification molding are conducted. The spinneret plate has 18 holes. The diameter of spinneret plate is 0.3 mm. The distance between spinneret orifice and coagulating bath is 35 cm. The coagulating bath is polyphosphoric acid solution with the mass fraction of 10%. The temperature of coagulating bath is 25° C. The winding speed is 50 m/min. Finally, the fiber is gained. The fiber is washed with the water whose weight is 80 times of fiber weight, and is dried for 12 h under the conditions of 45° C. and vacuum degree 0.07 MPa to gain the hydroxyl modified PBO/titanium dioxide/Zr doped zinc oxide fiber. The hydroxyl modified PBO/titanium dioxide/Zr doped zinc oxide fiber is cut to the length of 0.6 mm.

The preparation process of glass modified organic silicon resin is as follows:

(1) Methyl trichlorosilane and phenyl trichlorosilane whose weight is 0.3 times of weight of methyl trichlorosilane are added in the reaction vessel and mixed evenly. Then, absolute ethyl alcohol whose weight is 0.67 times of weight of methyl trichlorosilane is added and evenly mixed. Dimethyldichlorosilance whose weight is 0.6 times of weight of methyl trichlorosilane and diphenyl dichlorosilane whose weight is 0.5 times of weight of methyl trichlorosilane are added and evenly mixed to get the mixed liquid of raw materials. The temperature of feeding process system is kept at 0° C.

(2) Water, acetone and xylene are mixed under the environment temperature of 5° C. to get the reaction solvent whose volume is 2 times of mixed liquid volume of raw materials. Wherein, the volume of water is 2.8 times of that of absolute ethyl alcohol in Step (1). The volume ratio of acetone and xylene is 1:10;

(3) The mixed liquid of raw materials is added in the reaction solvent, and the temperature rises to 50° C. at the speed of 2° C./min. The mixed liquid is stirred for 40 min at the speed of 170 rpm. Then, it is put still for 4 h under 20° C. Then, aqueous phase is discarded, and organic phase is reserved. The organic phase is washed with the sodium bicarbonate solution with mass fraction of 1%. Then, saturated sodium chloride is used to wash the organic phase to be neutral. The volume ratio of organic phase, sodium bicarbonate solution and saturated sodium chloride is 1:0.5:2 to get the pre-polymerization solution of organic silicon resin;

(4) The glass whose weight is 0.13 times of weight of methyl trichlorosilane is added in the organic resin prepolymer and mixed for 20 min at the speed of 170 rmp;

(5) Xylene is removed under the conditions of 100° C. and vacuum degree 0.06 MPa to gain condensed silanol. The temperature of condensed silanol rises to 150° C., and thermal reaction is lasted for 1.5 h to gain the glass modified organic silicon resin.

The preparation process of Zr doped zinc oxide is as follows: zinc nitrate water solution with the molar concentration of 0.5 mol/L is prepared, and cetyl trimethyl ammonium bromide is added. The solid-to-liquid ratio of cetyl trimethyl ammonium bromide and zinc nitrate water solution is 0.009 g/mL, and they are mixed evenly to get mixed liquid A. Sodium hydroxide water liquid with the molar concentration of 2 mol/L is added under the stirring condition of 230 rpm. The volume ratio of mixed liquid A and sodium hydroxide water liquid is 1:1.2, and they are stirred for 30 min at the speed of 230 rpm to get the material I. Zirconium dichloride hydrate and water are mixed at the mass ratio of 1:20. Then, sodium hydroxide whose weight is 1.9 times of weight of zirconium dichloride hydrate is added and reacts for 40 min at the speed of 230 rpm to get the reaction liquid. The reaction liquid is centrifuged for 25 min at the speed of 3000 rpm, and the solid at the bottom is collected to get the material II. The material I and the material II are mixed and heated to 150° C. After thermal insulation for 40 min, the mixture of material I and material II is cooled to 25° C., and the reaction product is gathered. After the reaction product is washed respectively with the water whose weight is 100 times of reaction product weight and absolute ethyl alcohol whose weight is 70 times of reaction product weight, it is dried for 12 h under the condition of 50° C. and vacuum degree 0.08 MPa, and smashed to particles with the grain size of 100 nm to gain the Zr doped zinc oxide.

The method to prepare the anti-UV plastic for automobile interior ornaments includes the following steps:

S1 PC resin and ABS resin are dried respectively for 4 h under 85° C.;

S2 PC resin, ABS resin, antioxygen 1010, pentaerythritol stearate, pyrophyllite powder, hydroxyl modified PBO/titanium dioxide/Zr doped zinc oxide fiber and glass modified organic silicon resin are weighed according to the formula, and mixed for 8 min at the speed of 3000 rpm to get the mixture;

S3 The mixture is put in the extruder to extrude out. The temperature of feeding segment of the extruder is 190° C. The temperature of mixing segment is 240° C. The temperature of machine head is 210° C. The revolving speed of main machine is 80 rpm. Then, cooling and cutting into cylindrical particles with the diameter of 3 mm and length of 2 mm are conducted to get the anti-UV plastic for automobile interior ornaments.

Scratch resistance is tested for implementation example 6 by referring to ASTM G 171-03. It is found that, no obvious scratch can be seen with naked eyes, and the obvious scratch can be seen when the magnifying lens is magnified for 500 times.

### Test Example 1

Micro debonding method is used to test the interface property of PBO fiber and hydroxyl modified PBO fiber. The index is interfacial shear strength. The detailed test method refers to Liu Xiuying's Synthesis and Characterization of Carbon Propylene Fiber Reinforcement with Grafted Graphene Oxide in the 11th Issue of Chinese Journal of Inorganic Chemistry 2011.

See Tab. 1 for detailed test results.

TABLE 1
Interface property test results

| | Interfacial shear |
|---|---|
| | strength (MPa) |
| PBO fiber | 10.85 |
| Hydroxyl | 17.14 |
| modified PBO | |
| fiber | |

It can be seen from Tab. 1 that, after hydroxyl group is introduced, the interface adhesiveness between PBO fiber and resin matrix is enhanced. This may be because the introduction of hydroxyl group significantly improves surface activity of fiber, changes conjugate electron cloud system in PBO and causes fiber surface activation, thus enhancing interface adhesiveness property between fiber and matrix material.

### Test Example 2

Mechanical properties of anti-UV plastic for automobile interior ornaments in implementation examples 1-6 are tested.

Tensile property is tested according to GB/T 1040-92. The rate of tensile is 20 mm/min.

Bending property is rested according to GB/T 9341-2000. The rate of bending is 10 mm/min.

Notch impact strength is rested according to GB/T 16420-1996. The span is 40 mm, and the depth is 2 mm.

Tensile property and bending property are conducted on the universal material testing machine with the model of HTS-LLY9100 provided by Guangdong Zhongye Precision Equipment Co., Ltd.

Notch impact strength is carried out on the notch impact testing machine with the model of XJJ5 provided by Chengde Jinhe Instrument Manufacturing Co., Ltd.

The number of samples in each group of tests is 10, and the mean value is taken as the test result.

See Tab. 2 for detailed test results.

TABLE 2
Mechanical property test results

| | Tensile | Bending | |
|---|---|---|---|
| | property | property | Notch impact |
| | (MPa) | (MPa) | strength (KJ/m2) |
| Implementation | 48.6 | 53.8 | 67.6 |
| example 1 | | | |
| Implementation | 50.3 | 54.3 | 69.5 |
| example 2 | | | |
| Implementation | 52.9 | 54.6 | 72.8 |
| example 3 | | | |
| Implementation | 52.2 | 55.7 | 74.0 |
| example 4 | | | |
| Implementation | 53.5 | 56.9 | 77.3 |
| example 5 | | | |
| Implementation | 56.8 | 58.3 | 80.5 |
| example 6 | | | |

### Test Example 3

The light stability of anti-UV plastic for automobile interior ornaments in implementation examples 1-6 are tested. The samples are fixed on the sample holder of UV accelerated aging lamp box. The working temperature in the lamp box does not exceed 50° C. Manual UVB aging experiment is conducted for the samples. The radiation time is 400 h. The test conditions of UV lamp box are as follows:

(1) Working size: 450×1170×500 mm

(2) Sample size: 150×75 mm

(3) Tube space: 35 mm

(4) Distance between sample and tube: 50 mm

(5) UV wavelength: 340 nm

(6) Power: 40 W×6

(7) Radiation amount: ≤50 W/cm2

See Tab. 3 for detailed test results.

TABLE 3
Light stability test results

| | Tensile strength retention rate (%) |
|---|---|
| Implementation example 1 | 35.98 |
| Implementation example 2 | 57.52 |
| Implementation example 3 | 64.65 |
| Implementation example 4 | 70.38 |
| Implementation example 5 | 75.94 |
| Implementation example 6 | 84.17 |

The specific implementation examples are described above. We should understand that, common technical personnel in this field can conceive numerous modifications and changes according to this invention without the need of creative work. Thus, the technical proposals gained by technical personnel through logic analysis, reasoning or limited experiments on the basis of existing technology should be within the protection scope confirmed in the claim.

1. The anti-UV plastic for automobile interior ornaments is characterized by that, it is made from the following materials: PC resin, ABS resin, antioxygen, pentaerythritol stearate, inorganic filler, anti-UV fiber, organic silicon resin or modified organic silicon resin.

2. The anti-UV plastic for automobile interior ornaments according to claim 1 is characterized by that it is made from the materials which are prepared according to the following parts by weight: PC resin 25-30 parts, ABS resin 50-70 parts, antioxygen 1-2 parts, pentaerythritol stearate 1-3 parts, inorganic filler 0-5 parts, anti-UV fiber 15-20 parts, organic silicon resin or modified organic silicon resin 0.5-2 parts.

3. The anti-UV plastic for automobile interior ornaments according to claim 2, is characterized by that the antioxygen is one or several kinds among antioxygen 1098, antioxygen 1010, antioxygen 168, antioxygen 264, antioxygen T501 and antioxygen BHT.

4. The anti-UV plastic for automobile interior ornaments according to claim 2, is characterized by that the modified organic silicon resin is glass modified organic silicon resin. The anti-UV fiber is hydroxyl modified PBO fiber.

5. The anti-UV plastic for automobile interior ornaments according to claim 2, is characterized by that the preparation process of hydroxyl modified PBO fiber is as follows:
(1) 4,6-diaminodiphenyl diphenol hydrochloride, 2,5-dihydroxy terephthalic acid and terephthalic acid are used as polymerization monomers, and polyphosphoric acid is used as the solvent to polymerize for 64˜90 h under 65˜185° C. to gain the pre-polymerization solution;
(2) The pre-polymerization solution gained in Step (1) is spun to get the fiber. The fiber is washed with water and dried under vacuum condition to gain the hydroxyl modified PBO fiber.

6. The anti-UV plastic for automobile interior ornaments according to claim 2, is characterized by that the anti-UV fiber is hydroxyl modified PBO/inorganic UV absorbent fiber. The preparation process of hydroxyl modified PBO/inorganic UV absorbent fiber is as follows:
(1) 4,6-diaminodiphenyl diphenol hydrochloride, 2,5-dihydroxy terephthalic acid and terephthalic acid are used as polymerization monomers, and polyphosphoric acid is used as the solvent to polymerize for 34˜44 h under 65˜100° C. Then, the inorganic UV absorbent whose weight is 0.01-0.04 times of weight of 4,6-diaminodiphenyl diphenol hydrochloride is added to polymerize for 30˜46 h under 130˜185° C. to gain the pre-polymerization solution;
(2) The pre-polymerization solution gained in Step (1) is spun to get the fiber. The fiber is washed with water and dried under vacuum condition to gain the hydroxyl modified PBO/inorganic UV absorbent fiber.

7. The anti-UV plastic for automobile interior ornaments according to claim 6, is characterized by that the inorganic UV absorbent is one or the combination of titanium dioxide, zinc oxide and Zr doped zinc oxide.

8. The anti-UV plastic for automobile interior ornaments according to claim 2, is characterized by that the inorganic filler is one or several kinds among talcum powder, mica powder, kaolin, pyrophyllite powder, calcium carbonate, wollastonite, calcium sulfate and carbon black.

9. The method to prepare the anti-UV plastic for automobile interior ornaments is characterized by that, it includes the following steps:
S1 PC resin and ABS resin are dried respectively for 3˜5 h under 80˜85° C.;
S2 PC resin, ABS resin, antioxygen, pentaerythritol stearate, inorganic filler, anti-UV fiber, organic silicon resin or modified organic silicon resin are weighed according to the formula, and mixed for 5-10 min at the speed of 3000-5000 rpm to get the mixture;
S3 The mixture is put in the extruder to extrude out. The temperature of feeding segment of the extruder is 180˜190° C. The temperature of mixing segment is 230˜240° C. The temperature of machine head is 200˜210° C. The revolving speed of main machine is 80 100 rpm. Then, cooling and cutting into particles are conducted to get the anti-UV plastic for automobile interior ornaments.
